(19) United States
(12) Patent Application Publication
(10) Pub. No.: US 2024/0360575 A1
(43) Pub. Date: Oct. 31, 2024

(54) ELECTROCHEMICAL CELL

(71) Applicant: NGK INSULATORS, LTD., Nagoya-shi (JP)

(72) Inventors: Ryuhei OHARA, Nagoya-shi (JP); Yohei OKADA, Nagoya-shi (JP); Shinji FUJISAKI, Kuwana-shi (JP); Makoto OHMORI, Nagoya-shi (JP)

(21) Appl. No.: 18/766,848

(22) Filed: Jul. 9, 2024

Related U.S. Application Data
(63) Continuation of application No. PCT/JP2023/005286, filed on Feb. 15, 2023.

(30) Foreign Application Priority Data
Mar. 31, 2022 (JP) 2022-059522

(51) Int. Cl. C25B 11/077; C25B 11/031

(52) U.S. Cl. CPC C25B 11/0773; C25B 11/031

(57) ABSTRACT

An electrochemical cell includes a hydrogen electrode layer, an oxygen electrode layer, and an electrolyte layer disposed between the hydrogen electrode layer and the oxygen electrode layer. The hydrogen electrode layer is constituted by a perovskite type oxide, gadolinium-doped ceria and nickel. The perovskite type oxide includes gadolinium, chromium, and manganese.

### CROSS-REFERENCE TO RELATED APPLICATION

This is a continuation of PCT/JP2023/005286, filed Feb. 15, 2023, which claims priority from Japanese Application No. 2022-059522, filed Mar. 31, 2022 the entire content of which is hereby incorporated by reference.

### TECHNICAL FIELD

The present invention relates to an electrochemical cell.

### BACKGROUND ART

Conventionally, electrochemical cells (an electrolytic cell, a fuel cell, etc.) each including a hydrogen electrode layer, an oxygen electrode layer, and an electrolyte layer disposed between the hydrogen electrode layer and the oxygen electrode layer have been known (see e.g., JP 2020-155337A). The hydrogen electrode layer can be constituted by gadolinium-doped ceria (GDC) and nickel (Ni).

### SUMMARY

When an electrochemical cell is repeatedly operated and stopped, cracks may be generated in a porous hydrogen electrode layer. Accordingly, there is a need to reinforce the framework structure of the hydrogen electrode layer, thus suppressing the generation of cracks in the hydrogen electrode layer.

An object of the present invention is to provide an electrochemical cell capable of suppressing the generation of cracks in a hydrogen electrode layer.

An electrochemical cell according to a first aspect of the present invention includes a hydrogen electrode layer, an oxygen electrode layer, and an electrolyte layer disposed between the hydrogen electrode layer and the oxygen electrode layer. The hydrogen electrode layer is constituted by a perovskite type oxide, gadolinium-doped ceria and nickel. The perovskite type oxide includes gadolinium, chromium, and manganese.

An electrochemical cell according to a second aspect of the present invention relates to the above-described first aspect, wherein an average area occupancy rate of the perovskite type oxide in a cross section of the hydrogen electrode layer is 5.00% or less.

An electrochemical cell according to a third aspect of the present invention relates to the above-described first or second aspect, wherein the hydrogen electrode layer has a first region located on the electrolyte layer side with respect to a center of a thickness direction of the hydrogen electrode layer, and a second region located opposite to the electrolyte layer with respect to the center in the thickness direction, and a first area occupancy rate of the perovskite type oxide in the first region is smaller than a second area occupancy rate of the perovskite type oxide in the second region.

An electrochemical cell according to a fourth aspect of the present invention relates to any one of the first to third aspects, further including a plate-shaped metal support body supporting the hydrogen electrode layer and having a plurality of supply holes.

According to the present invention, it is possible to provide an electrochemical cell capable of suppressing the generation of cracks in a hydrogen electrode layer.

### BRIEF DESCRIPTION OF DRAWING

FIG. 1 is a cross-sectional view showing a configuration of an electrolytic cell according to an embodiment.

### DESCRIPTION OF EMBODIMENTS

### Electrolytic Cell 1

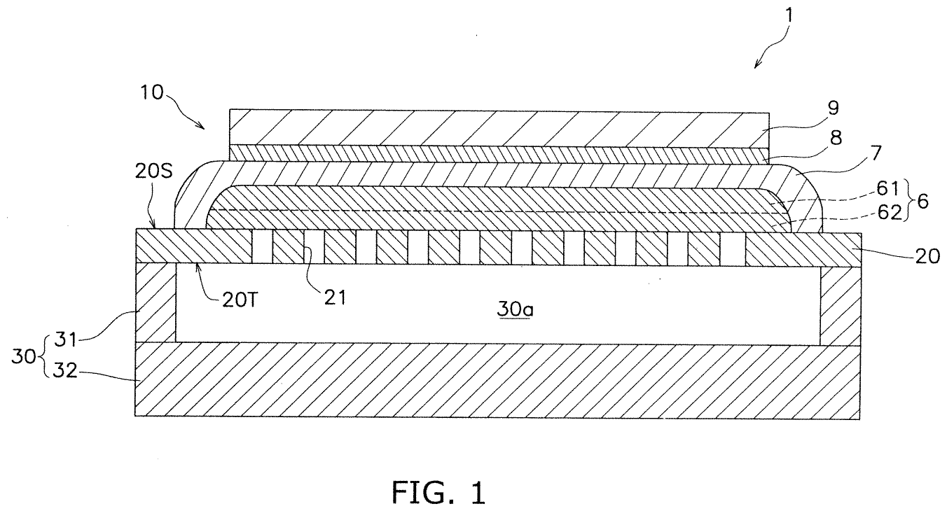

FIG. 1 is a cross-sectional view showing a configuration of an electrolytic cell 1 according to an embodiment. The electrolytic cell 1 is an example of an “electrochemical cell” according to the present invention.

The electrolytic cell 1 includes a cell body portion 10, a metal support body 20, and a flow path member 30.

### Cell Body Portion 10

The cell body portion 10 includes a hydrogen electrode layer 6 (cathode), an electrolyte layer 7, a reaction prevention layer 8, and an oxygen electrode layer 9 (anode). The hydrogen electrode layer 6, the electrolyte layer 7, the reaction prevention layer 8, and the oxygen electrode layer 9 are stacked in this order from the metal support body 20 side. The hydrogen electrode layer 6, the electrolyte layer 7, and the oxygen electrode layer 9 are essential components, and the reaction prevention layer 8 is an optional component.

### Hydrogen Electrode Layer 6

The hydrogen electrode layer 6 is disposed between the metal support body 20 and the electrolyte layer 7. The hydrogen electrode layer 6 is supported by the metal support body 20. Specifically, the hydrogen electrode layer 6 is disposed on a first principal surface 20S of the metal support body 20. The hydrogen electrode layer 6 covers a region of the first principal surface 20S of the metal support body 20, the region having a plurality of supply holes 21 provided therein. The hydrogen electrode layer 6 may extend into the supply holes 21.

A source gas is supplied to the hydrogen electrode layer 6 via the supply holes 21. The source gas contains CO₂ and H₂O. The hydrogen electrode layer 6 produces H₂, CO, and O²⁻ from the source gas according to an electrochemical reaction of co-electrolysis represented by the following formula (1):

Hydrogen electrode layer 6: CO₂+H₂O+4e⁻→CO+H₂+2O²⁻ (1)

The hydrogen electrode layer 6 is made of a porous material having electron conductivity. In the present embodiment, the hydrogen electrode layer 6 is constituted by: a perovskite type oxide (hereinafter abbreviated as a “Gd(Cr, Mn) oxide”) including gadolinium (Gd), chromium (Cr), and manganese (Mn); gadolinium-doped ceria (GDC); and nickel (Ni). The Gd(Cr, Mn) oxide is a perovskite type oxide represented by a general formula ABO₃. Gd is placed in an A-site, and Cr and Mn are placed in a B-site.

In this manner, the hydrogen electrode layer 6 containing the Gd(Cr, Mn) oxide can enhance the sinterability (neck growth between particles) of the hydrogen electrode layer 6, thus making it possible to reinforce the framework structure of the porous hydrogen electrode layer 6. Accordingly, it is possible to suppress the generation of cracks in the hydrogen electrode layer 6.

Here, for the electrolytic cell 1, which is a metal-supported cell, the hydrogen electrode layer 6 needs to be formed by a heat treatment at a low temperature in order to suppress the degradation of the metal support body 20, and the framework formation of the hydrogen electrode layer 6 is likely to be insufficient. Therefore, for the electrolytic cell 1, which is a metal-supported cell, it is particularly useful to successfully suppress cracking by reinforcing the framework structure of the hydrogen electrode layer 6.

The Gd(Cr, Mn) oxide is represented by a general formula ABO₃. The Gd(Cr, Mn) oxide is electrically insulating.

As shown in FIG. 1, the hydrogen electrode layer 6 according to the present embodiment includes a first region 61 located on the electrolyte layer 7 side with respect to a center (the dashed line in FIG. 1) in the thickness direction of the hydrogen electrode layer 6, and a second region 62 located opposite to the electrolyte layer 7 with respect to the center in the thickness direction. The thickness direction is a direction perpendicular to the first principal surface 20S of the metal support body 20. The area occupancy rate of the Gd(Cr, Mn) oxide in a cross section of the hydrogen electrode layer 6 will be described later.

Ni is preferably present in the form of metallic Ni in a reducing atmosphere while the electrolytic cell 1 is operated, but may be present in the form of NiO in an oxidizing atmosphere while the electrolytic cell 1 is stopped.

The porosity of the hydrogen electrode layer 6 can be, but is not particularly limited to, 5% or more and 70% or less, for example. The thickness of the hydrogen electrode layer 6 can be, but is not particularly limited to, 1 μm or more and 100 μm or less, for example.

The hydrogen electrode layer 6 can be formed by firing.

### Electrolyte Layer 7

The electrolyte layer 7 is disposed between the hydrogen electrode layer 6 and the oxygen electrode layer 9. The electrolyte layer 7 covers the whole of the entire hydrogen electrode layer 6. Since the reaction prevention layer 8 is disposed between the electrolyte layer 7 and the oxygen electrode layer 9 in the present embodiment, the electrolyte layer 7 is in contact with the reaction prevention layer 8.

The outer edge of the electrolyte layer 7 is joined to the first principal surface 20S of the metal support body 20. This can secure the airtightness between the hydrogen electrode layer 6 side and the oxygen electrode layer 9 side, and it is therefore not necessary to provide separate sealing between the metal support body 20 and the electrolyte layer 7.

The electrolyte layer 7 allows the O²⁻ produced in the hydrogen electrode layer 6 to be transmitted to the oxygen electrode layer 9. The electrolyte layer 7 is made of a dense material having oxide ion conductivity. The electrolyte layer 7 can be made of, for example, 8YSZ, LSGM (lanthanum gallate), or the like.

The electrolyte layer 7 is a fired body made of a dense material having ion conductivity and not having electron conductivity. The electrolyte layer 7 can be made of, for example, YSZ (8YSZ), GDC, ScSZ, SDC, LSGM (lanthanum gallate), or the like.

The porosity of the electrolyte layer 7 can be, but is not particularly limited to, 0.1% or more and 7% or less, for example. The thickness of the electrolyte layer 7 can be, but is not particularly limited to, 1 μm or more and 100 μm or less, for example.

### Reaction Prevention Layer 8

The reaction prevention layer 8 is disposed between the electrolyte layer 7 and the oxygen electrode layer 9. The reaction prevention layer 8 is disposed opposite to the hydrogen electrode layer 6 with the electrolyte layer 7 interposed therebetween. In the present embodiment, the reaction prevention layer 8 is connected to the electrolyte layer 7. The reaction prevention layer 8 has the function of suppressing the electrolyte layer 7 and the oxygen electrode layer 9 from reacting each other to form a reaction layer having a high electrical resistance.

The reaction prevention layer 8 is made of an ion-conductive material. The reaction prevention layer 8 can be made of GDC, SDC, or the like.

The porosity of the reaction prevention layer 8 can be, but is not particularly limited to, 0.1% or more and 50% or less, for example. The thickness of the reaction prevention layer 8 can be, but is not particularly limited to, 1 μm or more and 50 μm or less, for example.

### Oxygen Electrode Layer 9

The oxygen electrode layer 9 is disposed opposite to the hydrogen electrode layer 6 with respect to the electrolyte layer 7. In the present embodiment, the electrolytic cell 1 includes the reaction prevention layer 8, and therefore the oxygen electrode layer 9 is disposed on the reaction prevention layer 8. When the electrolytic cell 1 does not include the reaction prevention layer 8, the oxygen electrode layer 9 is disposed on the electrolyte layer 7.

According to a chemical reaction represented by the following formular (2), the oxygen electrode layer 9 produces 02 from the O²⁻ transmitted from the hydrogen electrode layer 6 via the electrolyte layer 7.

Oxygen electrode layer 9: 2O²⁻→O₂+4e⁻ (2)

The oxygen electrode layer 9 is made of a porous material having oxide ion conductivity and electron conductivity. The oxygen electrode layer 9 can be made of, for example, a composite of an oxide-ion-conductive material (e.g., GDC) and one or more of (La, Sr)(Co, Fe)O₃, (La, Sr)FeO₃, La(Ni, Fe)O₃, (La, Sr)CoO₃, and (Sm, Sr)COO₃.

The porosity of the oxygen electrode layer 9 can be, but it not particularly limited to, 20% or more and 60% or less, for example. The thickness of the oxygen electrode layer 9 can be, but is not particularly limited to, 1 μm or more and 100 μm or less, for example.

The method for forming the oxygen electrode layer 9 is not particularly limited, and it is possible to use firing, spray coating, PVD, CVD, and the like.

### Metal Support Body 20

The metal support body 20 supports the cell body portion 10. The metal support body 20 is formed in a plate shape. The metal support body 20 may have a flat plate shape or a curved plate shape. The metal support body 20 need only be able to maintain the strength of the electrolytic cell 1, and the thickness of the metal support body 20 can be, but is not particularly limited to, 0.1 mm or more and 2.0 mm or less, for example.

The metal support body 20 has a plurality of supply holes 21, a first principal surface 20S, and a second principal surface 20T.

The supply holes 21 extend through the metal support body 20 from the first principal surface 20S to the second principal surface 20T. The supply holes 21 are open to the first principal surface 20S and the second principal surface 20T. The supply holes 21 are formed in a region of the first principal surface 20S that is joined to the hydrogen electrode layer 6. The supply holes 21 are connected to a flow path 30a formed between the metal support body 20 and the flow path member 30.

The supply holes 21 can be formed, for example, by machining (e.g., punching), laser processing, or chemical processing (e.g., etching). Alternatively, when the metal support body 20 is made of a porous metal, the supply holes 21 may be pores within the porous metal. Accordingly, the supply holes 21 need not be formed perpendicularly to the first principal surface 20S and the second principal surface 20T.

The cell body portion 10 is joined to the first principal surface 20S. The flow path member 30 is joined to the second principal surface 20T. The first principal surface 20S is provided opposite to the second principal surface 20T.

The metal support body 20 is made of a metal material. For example, the metal support body 20 is made of an alloy material containing Cr (chromium). Examples of such a metal material include Fe—Cr—Mn-based alloy steel and Ni—Cr—Mn-based alloy steel. The Cr content in the metal support body 20 can be, but is not particularly limited to, 4 mass % or more and 30 mass % or less. The Mn content in the metal support body 20 can be, but is not particularly limited to, 0 mass % or more and 1 mass % or less.

The metal support body 20 may contain Ti (titanium) and Zr (zirconium). The Ti content in the metal support body 20 can be, but is not particularly limited to, 0.01 mol % or more and 1.0 mol % or less. The Zr content in the metal support body 20 can be, but is not particularly limited to, 0.01 mol % or more and 0.4 mol % or less. The metal support body 20 may contain Ti in the form of TiO₂ (titania), and may contain Zr in the form of ZrO₂ (zirconia).

The metal support body 20 may have, on the surface thereof, an oxide film formed by oxidation of the constituent elements of the metal support body 20. A typical example of the oxide film is a chromium oxide film. The oxide film partly or entirely covers the surface of the metal support body 20. Also, the oxide film may partly or entirely cover the inner wall surface of each of the supply holes 21.

### Flow Path Member 30

The flow path member 30 is joined to the second principal surface 20T of the metal support body 20. The flow path member 30 forms the flow path 30a between the metal support body 20 and itself. A source gas is supplied to the flow path 30a. The source gas supplied to the flow path 30a is supplied to the hydrogen electrode layer 6 of the cell body portion 10 via the supply holes 21 of the metal support body 20.

The flow path member 30 can be made of, for example, an alloy material. The flow path member 30 may be made of the same material as the metal support body 20. In this case, the flow path member 30 may be substantially integrated in one piece with the metal support body 20.

The flow path member 30 includes a frame body 31 and an interconnector 32. The frame body 31 is an annular member surrounding lateral sides of the flow path 30a. The frame body 31 is joined to the second principal surface 20T of the metal support body 20. The interconnector 32 is a plate-shaped member that electrically connects the electrolytic cell 1 in series to an external power supply or another electrolytic cell. The interconnector 32 is joined to the frame body 31.

In this manner, the flow path member 30 according to the present embodiment includes the frame body 31 and the interconnector 32 as separate members; however, the frame body 31 and the interconnector 32 may be integrated in one piece.

### Area Occupancy Rate of Gd(Cr, Mn) Oxide in Hydrogen Electrode Layer 6

As stated above, the hydrogen electrode layer 6 is constituted by the GDC, the Gd(Cr, Mn) oxide, and Ni.

The average area occupancy rate of the Gd(Cr, Mn) oxide in the hydrogen electrode layer 6 is preferably 5.00% or less. With this rate, it is possible to inhibit an excessive presence of the electrically insulating Gd(Cr, Mn) oxide, thus securing the electrical conductivity required for the hydrogen electrode layer 6.

The lower limit of the average area occupancy rate of the Gd(Cr, Mn) oxide in the hydrogen electrode layer 6 can be, but is not particularly limited to, 0.50% or more. An average area occupancy rate of less than 0.50% is difficult to be accurately detected by the calculation method described below.

The average area occupancy rate of the Gd(Cr, Mn) oxide can be calculated in the following manner.

First, the hydrogen electrode layer 6 is cut along the thickness direction thereof.

Next, a cross section of the hydrogen electrode layer 6 is polished using a precision instrument, and then subjected to ion milling processing using an IM4000 manufactured by Hitachi High-Technologies Corporation.

Next, an enlarged SEM image at a magnification of 10000× of a given position in the first region 61 of the hydrogen electrode layer 6 is obtained with a field emission scanning electron microscope (FE-SEM) using an in-lens secondary electron detector.

Next, the luminance of the SEM image is classified into 256 gradations, to obtain three values for the respective contrasts of the main phase, the Ni phase, and the gas phase. The main phase includes the GDC and the Gd(Cr, Mn) oxide. The Ni phase includes Ni. The main phase and the Ni phase are solid phases.

Next, using an energy dispersive X-ray spectroscopy (EDX), an EDX spectrum at the position of the main phase is obtained. Then, the EDX spectrum is subjected to semi-quantitative analysis, to identify the elements present at the position of the main phase. Thus, on the SEM image, the main phase is divided into a region in which the GDC is present and a region in which the Gd(Cr, Mn) oxide is present.

Next, the SEM image is subjected to image analysis using image analysis software HALCON manufactured by MVTec GmbH (Germany), to obtain an analysis image in which the Gd(Cr, Mn) oxide is highlighted.

Next, the total area of the Gd(Cr, Mn) oxide in the analysis image is divided by the entire area of the solid phase (i.e., the region excluding the gas phase), to determine a first area occupancy rate of the Gd(Cr, Mn) oxide in the first region 61.

A second area occupancy rate of the Gd(Cr, Mn) oxide in the second region 62 is determined by the same method as that used for the first area occupancy rate of the Gd(Cr, Mn) oxide in the first region 61.

Then, the arithmetic average value of the first and second area occupancy rates is determined as the average area occupancy rate of the Gd(Cr, Mn) oxide in the hydrogen electrode layer 6.

Here, the first area occupancy rate of the Gd(Cr, Mn) oxide in the first region 61 is preferably smaller than the second area occupancy rate of the Gd(Cr, Mn) oxide in the second region 62. This makes it possible to reinforce the framework structure of the second region 62 to which a thermal stress due to the difference in coefficient of thermal expansion from the metal support body 20 is likely to be applied, while securing a three-phase interface (reaction site) in the first region 61 in which electrode reactions actively take place. Thus, it is possible to achieve both the preservation of the electrode performance and the suppression of cracking.

The value of the first area occupancy rate of the Gd(Cr, Mn) oxide in the first region 61 can be, but is not particularly limited to, 0.50% or more and 10.0% or less, for example. The value of the second area occupancy rate of the Gd(Cr, Mn) oxide in the second region 62 can be, but is not particularly limited to, 0.50% or more and 10.0% or less, for example.

### Modifications of Embodiment

Although an embodiment of the present invention has been described thus far, the present invention is not limited thereto, and various alterations can be made without departing from the gist of the present invention.

### Modification 1

In the above embodiment, the hydrogen electrode layer 6 functions as a cathode, and the oxygen electrode layer 9 functions as an anode; however, the hydrogen electrode layer 6 may function as an anode, and the oxygen electrode layer 9 may function as a cathode. In this case, the constituent materials of the hydrogen electrode layer 6 and the oxygen electrode layer 9 are interchanged, and the source gas is flowed over the outer surface of the hydrogen electrode layer 6.

### Modification 2

In the above embodiment, the electrolytic cell 1 is described as an example of the electrochemical cell; however, the electrochemical cell is not limited to an electrolytic cell. An electrochemical cell is a generic term for an element in which, for converting electrical energy into chemical energy, a pair of electrodes are disposed such that an overall oxidation-reduction reaction produces an electromotive force, and an element for converting chemical energy to electrical energy. Therefore, electrochemical cells include, for example, fuel cells using oxide ions or protons as a carrier.

### Modification 3

In the above embodiment, the reaction prevention layer 8 is connected to the electrolyte layer 7 since the electrolytic cell 1 includes the reaction prevention layer 8. However, when the electrolytic cell 1 does not include the reaction prevention layer 8, the oxygen electrode layer 9 is connected to the electrolyte layer 7.

### EXAMPLES

Examples of the electrochemical cell according to the present invention will be described below. However, the present invention is not limited to the examples described below.

### Examples 1 to 10

Electrolytic cells according to Examples 1 to 10 were produced as follows.

First, a metal support body made of Fe—Cr—Mn-based alloy steel and having a plurality of supply holes formed therein was prepared.

Next, GDC powder, Gd(Cr, Mn) oxide powder, NiO powder, a butyral resin, polymethyl methacrylate beads serving as a pore-forming material, a plasticizer, a dispersing agent, and a solvent were mixed, to prepare a slurry for a hydrogen electrode layer. At this time, the average area occupancy rate of the Gd(Cr, Mn) oxide in the hydrogen electrode layer was varied as shown in Table 1 by adjusting the amount of the Gd(Cr, Mn) oxide powder added. Then, the slurry for a hydrogen electrode layer was printed on a first principal surface of the metal support body by doctor blading, to form a molded body of a hydrogen electrode layer.

Next, YSZ powder, a butyral resin, a plasticizer, a dispersing agent, and a solvent were mixed, to prepare a slurry for an electrolyte layer. Then, the slurry for an electrolyte was printed, by doctor blading, so as to cover the molded body of a hydrogen electrode layer, to form a molded body of an electrolyte layer.

Next, GDC powder, polyvinyl alcohol, and a solvent were mixed, to prepare a slurry for a reaction prevention layer. Then, the slurry for a reaction prevention layer was printed onto the molded body of an electrolyte layer by doctor blading, to form a molded body of a reaction prevention layer.

Then, the respective molded bodies of a hydrogen electrode layer, an electrolyte layer, and a reaction prevention layer sequentially disposed on the metal support body were fired (1050° C., 1 hour) in the atmosphere, to form a hydrogen electrode layer, an electrolyte layer, and a reaction prevention layer.

Next, (La, Sr)(Co, Fe)O₃ powder, polyvinyl alcohol, and a solvent were mixed, to prepare a slurry for an oxygen electrode layer. Then, the slurry for an oxygen electrode layer was printed onto the reaction prevention layer by doctor blading, to form a molded body of an oxygen electrode layer.

Next, the molded body of an oxygen electrode layer was fired (1000° C., 1 hour) in the atmosphere, to form an oxygen electrode.

Finally, crystallized glass was used to connect a flow path member made of Fe—Cr—Mn-based alloy steel to a second principal surface of the metal support body. As a result of the foregoing, the electrolytic cells according to Examples 1 to 10 were completed.

### Comparative Example 1

An electrolytic cell according to Comparative Example 1 was produced using the same process as that used for Examples 1 to 10 except that the slurry for a hydrogen electrode layer was prepared without using the Gd(Cr, Mn) oxide powder.

### Area Occupancy Rate of Gd(Cr, Mn) Oxide in Hydrogen Electrode Layer

Using the method described in the above embodiment, the area occupancy rate of the Gd(Cr, Mn) oxide in the hydrogen electrode layer was calculated. The calculation results were as shown in Table 1.

### Thermal Cycling Test

In a state in which a reducing atmosphere was maintained by supplying a gas mixture of Ar and hydrogen (containing 4% of hydrogen relative to Ar) to the hydrogen electrode layer from the flow path inside the flow path member, the temperature was increased from room temperature to 750° C. in 2 hours, and then decreased to room temperature in 4 hours. This process was taken as one cycle, and the cycle was repeated 10 times.

Thereafter, a cross section of the hydrogen electrode was observed with an FE-SEM to determine whether any cracks having a length of 1 μm or more were generated in the hydrogen electrode. In Table 1, the electrolytic cells in which the cracks were not generated in the hydrogen electrode were evaluated as “Good”, and the electrolytic cell in which the cracks were generated in the hydrogen electrode was evaluated as “Poor”.

### Initial Performance Evaluation

In a state in which the temperature of each of the electrolytic cells was increased to 750° C., a current with a value of 0.5 A/cm² was swept through the electrolytic cell while supplying a gas mixture of water vapor and hydrogen (mixing ratio 50:50) to the hydrogen electrode layer from the flow path inside the flow path member, and supplying air to the oxygen electrode layer, and the electrolytic voltage of the electrolytic cell at this time was obtained. Then, using the electrolytic voltage of Comparative Example 1 as a reference, the rate of increase in electrolytic voltage was calculated using the following formula (3):

Rate of increase in electrolytic voltage of each example(%)=100×((Electrolytic voltage of each example)−(Electrolytic voltage of Comparative Example 1))/(Electrolytic voltage of Comparative Example 1) (3)

In Table 1, the electrolytic cells with a rate of increase in electrolytic voltage of less than 1% were evaluated as “Good”, and the electrolytic cells with a rate of increase in electrolytic voltage of 1% or more were evaluated as “Fair”.

TABLE 1

| | | Average area | | |
|---|---|---|---|---|
| | Addition of | occupancy rate | Thermal | Initial |
| | Gd(Cr, Mn) | of Gd(Cr, Mn) | cycling test | performance |
| Sample | oxide | oxide (%) | evaluation | evaluation |
| Example 1 | Added | 0.50 | Good | Good |
| Example 2 | Added | 0.98 | Good | Good |
| Example 3 | Added | 1.54 | Good | Good |
| Example 4 | Added | 2.48 | Good | Good |
| Example 5 | Added | 3.12 | Good | Good |
| Example 6 | Added | 3.55 | Good | Good |
| Example 7 | Added | 4.21 | Good | Good |
| Example 8 | Added | 5.00 | Good | Good |
| Example 9 | Added | 6.11 | Good | Fair |
| Example 10 | Added | 10.1 | Good | Fair |
| Comparative | Not added | 0 | Poor | Reference |
| Example 1 | | | | |

As shown in Table 1, in Examples 1 to 10, in which the hydrogen electrode layer contained the Gd(Cr, Mn) oxide, the generation of cracks in the hydrogen electrode layer was suppressed. Such a result was obtained because the framework structure of the porous hydrogen electrode layer was reinforced by enhancing the sinterability (neck growth between particles) of the hydrogen electrode layer. This effect is useful in a metal-supported cell, which is difficult to be fired at high temperature.

In Examples 1 to 8, in which the average area occupancy rate of the Gd(Cr, Mn) oxide was 5.00% or less, sufficient initial performance was maintained. Such a result was obtained because an excessive presence of the electrically insulating Gd(Cr, Mn) oxide was inhibited.

### Examples 11 to 14

Electrolytic cells according to Examples 11 to 14 were produced using the same process as that used for Examples 1 to 10 except that the hydrogen electrode layer had a two-layer structure. Here, only the method for forming a hydrogen electrode layer having a two-layer structure will be described.

First, GDC powder, Gd(Cr, Mn) oxide powder, NiO powder, a butyral resin, polymethyl methacrylate beads serving as a pore-forming material, a plasticizer, a dispersing agent, and a solvent were mixed, to separately prepare a slurry for a first region and a slurry for a second region. Then, the slurry for a second region was printed onto the first principal surface of the metal support body, to form a molded body for a second region, and thereafter the slurry for a first region was printed onto the molded body for a second region, to form a molded body for a first region.

Here, in Examples 11 and 13, the amount of the Gd(Cr, Mn) oxide powder added in the slurry for a first region was adjusted to be smaller than the amount of the Gd(Cr, Mn) oxide powder added in the slurry for a second region. Thus, as shown in Table 2, the average area occupancy rate of the Gd(Cr, Mn) oxide in the first region of the hydrogen electrode layer was smaller than the average area occupancy rate of the Gd(Cr, Mn) oxide in the second region of the hydrogen electrode layer.

For Examples 11 to 14, the measurement of the area occupancy rate of the Gd(Cr, Mn) oxide, the thermal cycling test, and the initial performance evaluation were performed in the same manner as in Examples 1 to 10.

The measurement results are shown in Table 2. In Table 2, the electrolytic cells in which the cracks were not generated in the hydrogen electrode in the thermal cycling test were evaluated as “Good”. In Table 2, for the initial performance evaluation, the electrolytic cell with a rate of increase in electrolytic voltage of less than 0.5% was evaluated as “A”, the electrolytic cell with a rate of increase in electrolytic voltage of greater than or equal to 0.5% and less than 1% was evaluated as “B”, and the electrolytic cell with a rate of increase in electrolytic voltage of greater than or equal to 1.0% and less than 3.0% was evaluated as “C”, and the electrolytic cell with a rate of increase in electrolytic voltage of greater than or equal to 3.0% and less than 10% was evaluated as “D”.

TABLE 2

| | | Average area | | | | |
|---|---|---|---|---|---|---|
| | Addition of | occupancy rate | Area occupancy | Area occupancy | Thermal | Initial |
| | Gd(Cr, Mn) | of Gd(Cr, Mn) | rate in first | rate in second | cycling test | performance |
| Sample | oxide | oxide (%) | region (%) | region (%) | evaluation | evaluation |
| Example 11 | Added | 1.05 | 0.6 | 1.5 | Good | A |
| Example 12 | Added | 1.00 | 1.4 | 0.6 | Good | B |
| Example 13 | Added | 6.00 | 4.9 | 7.1 | Good | C |
| Example 14 | Added | 6.05 | 7.1 | 5.0 | Good | D |

As shown in Table 2, in Example 11, in which the average area occupancy rate of the Gd(Cr, Mn) oxide in the first region of the hydrogen electrode layer was smaller than the average area occupancy rate of the Gd(Cr, Mn) oxide in the second region of the hydrogen electrode layer, the initial performance was further enhanced as compared with Example 12. This is because a three-phase interface in the first region was secured by reducing the area occupancy rate of the Gd(Cr, Mn) oxide in the first region in which electrode reactions actively take place.

Similarly, in Example 13, in which the average area occupancy rate of the Gd(Cr, Mn) oxide in the first region of the hydrogen electrode layer was smaller than the average area occupancy rate of the Gd(Cr, Mn) oxide in the second region of the hydrogen electrode layer, the initial performance was further enhanced as compared with Example 14.

Note that in Examples 11 and 12, in which the average area occupancy rate of the Gd(Cr, Mn) oxide was 5.00% or less, the initial performance was further enhanced as compared with Examples 13 and 14.

### REFERENCE SIGNS LIST

1 Cell
6 Hydrogen electrode layer
61 First region
62 Second region
7 Electrolyte layer
8 Reaction prevention layer
9 Oxygen electrode layer
10 Cell body portion
20 Metal support body
21 Supply hole
30 Flow path member
30a Flow path

1. An electrochemical cell comprising:
a hydrogen electrode layer;
an oxygen electrode layer; and
an electrolyte layer disposed between the hydrogen electrode layer and the oxygen electrode layer, wherein
the hydrogen electrode layer is constituted by a perovskite type oxide, gadolinium-doped ceria and nickel, the perovskite type oxide including gadolinium, chromium, and manganese.

2. The electrochemical cell according to claim 1, wherein
an average area occupancy rate of the perovskite type oxide in a cross section of the hydrogen electrode layer is 5.00% or less.

3. The electrochemical cell according to claim 1, wherein
the hydrogen electrode layer has a first region located on the electrolyte layer side with respect to a center of a thickness direction of the hydrogen electrode layer, and a second region located opposite to the electrolyte layer with respect to the center in the thickness direction, and
a first area occupancy rate of the perovskite type oxide in the first region is smaller than a second area occupancy rate of the perovskite type oxide in the second region.

4. The electrochemical cell according to claim 1, further comprising
a plate-shaped metal support body supporting the hydrogen electrode layer and having a plurality of supply holes.
